(19) United States
(12) Patent Application Publication
(10) Pub. No.: US 2024/0266781 A1
(43) Pub. Date: Aug. 8, 2024

(54) PLUG CONNECTOR WITH LOCKING ELEMENT

(71) Applicant: PHOENIX CONTACT GMBH & CO. KG, Blomberg (DE)

(72) Inventor: Ralf GESKE, Schieder-Schwalenberg (DE)

(21) Appl. No.: 18/567,406

(22) PCT Filed: Jun. 13, 2022
(86) PCT No.: PCT/EP2022/065980

§ 371 Date: Dec. 6, 2023

(30) Foreign Application Priority Data
Jun. 17, 2021 (LU) LU500295

(51) Int. Cl. H01R 13/627

(52) U.S. Cl. CPC H01R 13/6275

(57) ABSTRACT

A plug connector includes at least one plug-in contact for forming an electrical plug connection with at least one mating plug-in contact of a mating plug connector in a plug-in direction. On a side of a plug-in face of the plug connector, the at least one plug-in contact extends at least partially from a first end wall of a housing of the plug connector in the plug-in direction. The plug connector has a locking element for locking the electrical plug connection with the mating plug connector, the locking element being arranged in the housing and extending at least partially through a passage in the first end wall in a direction of the at least one plug-in contact. The locking element is resilient at least in certain portions and is mounted in the housing. The locking element is accessible via an actuating opening on the housing.

### CROSS-REFERENCE TO PRIOR APPLICATIONS

This application is a U.S. National Phase application under 35 U.S.C. § 371 of International Application No. PCT/EP2022/065980, filed on Jun. 13, 2022, and claims benefit to Luxembourg Patent Application No. LU 500295, filed on Jun. 17, 2021. The International Application was published in German on Dec. 22, 2022 as WO/2022/263353 A1 under PCT Article 21(2).

### FIELD

The present invention relates to a plug connector, preferably a row plug connector, having at least one plug-in contact for forming an electrical plug connection with at least one mating plug-in contact of a mating plug connector, preferably a row plug connector, in a plug-in direction.

### BACKGROUND

Plug connectors with locking mechanisms are known from the prior art in different configurations and designs.

For example, in the German patent specification DE 10 2010 017 262 B4, a connection plug with a plug housing is described for plugging onto a basic housing and with a rocker-like locking device for locking the connection plug on the basic housing.

Further plug connectors with locking mechanisms from the prior art are known, for example, from CN 110994265 A, US 2019/0280403 A1, DE 10 2014 115 252 A1, DE 20 2009 002 159 U1, DE 20 2007 005 300 U1, DE 10 2020 110 979 A1, DE 10 2017 124 670 A1, EP 3 462 546 B1 and EP 3 389 149 A1.

### SUMMARY

In an embodiment, the present invention provides a plug connector, comprising: at least one plug-in contact configured to form an electrical plug connection with at least one mating plug-in contact of a mating plug connector in a plug-in direction, wherein on a side of a plug-in face of the plug connector, the at least one plug-in contact extends at least partially from a first end wall of a housing of the plug connector in the plug-in direction, wherein the plug connector has a locking element configured to lock the electrical plug connection with the mating plug connector, the locking element being arranged in the housing and extending at least partially through a passage in the first end wall in a direction of the at least one plug-in contact, wherein the locking element is resilient at least in certain portions and is mounted in the housing, and wherein the locking element is accessible via an actuating opening on the housing and is actuatable in at least one second direction.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1a shows a perspective view of an exemplary embodiment of a plug connector according to the present invention:

FIG. 1b shows a perspective view of an exemplary embodiment of a mating plug connector which is configured to form an electrical plug connection with the plug connector shown in FIG. 1a;

FIG. 2 shows a perspective view of an exemplary embodiment of an actuating element of a plug connector according to the present invention:

FIG. 3a shows a perspective view of an exemplary embodiment of a locking element of a plug connector according to the present invention:

FIG. 3b shows a front view of the locking element shown in FIG. 3a:

FIG. 4a shows a sectional view (side view) of the plug connector shown in FIG. 1a:

FIG. 4b shows a sectional view (plan view) of a second housing part of the plug connector shown in FIG. 1a:

FIG. 5a shows a sectional view (side view) of the plug connector shown in FIG. 1a when an electrical plug connection is formed with the mating plug connector shown in FIG. 1b in a locked state (without actuating element):

FIG. 5b shows a further sectional view (side view) of the plug connector shown in FIG. 1a when an electrical plug connection is formed with the mating plug connector shown in FIG. 1b in a locked state, wherein an actuating element is inserted in the plug connector and is not actuated; and

FIG. 5c shows a further sectional view (side view) of the plug connector shown in FIG. 1a when an electrical plug connection is formed with the mating plug connector shown in FIG. 1b in an unlocked state, wherein an actuating element is inserted in the plug connector and is actuated.

### DETAILED DESCRIPTION

In an embodiment, the present invention provides an improved plug connector with a locking element, which is characterized primarily by simple handling, a compact structure and preferably by an increased safety aspect.

According to a first general aspect, the invention relates to a plug connector, preferably a row plug connector, having at least one plug-in contact for forming an electrical plug connection with at least one mating plug-in contact of a mating plug connector, preferably a row mating connector, in a plug-in direction, wherein, on the side of a plug-in face of the plug connector, the at least one plug-in contact extends at least partially from a first end wall of a housing of the plug connector in the plug-in direction, wherein the plug connector has a locking element for locking the electrical plug connection with the mating plug connector, which locking element is arranged in the housing and extends through a passage in the first end wall at least partially in the direction of the at least one plug-in contact, preferably in the plug-in direction, wherein the locking element is of resilient design at least in certain portions and is mounted in the housing, wherein the locking element is accessible via an actuating opening on the housing and can be actuated in at least one second direction, preferably perpendicular to the plug-in direction.

According to a further aspect of the invention, it can be provided that the actuating opening is formed on the housing on the side of the plug connector opposite the plug-in face in the plug-in direction and/or is designed to insert an actuating element for the locking element, preferably in the plug-in direction.

It is possible for a clamping portion of the locking element to be fastened at least partially to a second end wall of the housing on the side of the plug connector opposite the plug-in face in the plug-in direction, preferably clamped at least in certain portions and/or latched at least in certain portions.

According to a further aspect of the invention, it can be provided that the locking element has outside of the housing a locking portion with a latching element for forming a releasable latching connection with a latching portion of the mating plug connector, wherein the locking portion is preferably plate-shaped and/or the latching element has a substantially trapezoidal or substantially triangular contour in one view, preferably in a side view.

It is possible for the locking element to have an actuating portion, preferably for actuation by an actuating element, wherein the actuating portion is arranged on the locking element between the passage and the actuating opening.

According to a further aspect of the invention, it can be provided that the plug connector has a guide channel for inserting an actuating element, preferably substantially in the plug-in direction.

The guide channel can be formed at least in certain portions by the locking element and/or by an outer wall of the housing adjoining the actuating opening.

It is possible for the guide channel to be delimited in the plug-in direction at least by the first end wall on the side of the plug-in face, wherein the first end wall has a bearing portion for the pivotable mounting of the actuating element.

In one view, preferably in a cross-sectional view, the bearing portion can have, at least in certain portions, a substantially wedge-shaped or substantially U-shaped contour for receiving a support portion of the actuating element.

According to a further aspect of the invention, it can be provided that the plug connector has an actuating element and the actuating element is preferably designed as an actuating lever and is clamped, at least in certain portions, to the outer wall by the locking element when inserted through the actuating opening in the non-actuated state.

It is possible for the actuating element to have an engagement portion which forms an operative connection with the locking element, preferably with an actuating portion of the locking element, in order to be able to actuate the locking element via the actuating element and/or to hold the actuating element in the housing, preferably to clamp it in an actuatable manner, by means of the locking element.

Identical or functionally equivalent components or elements are denoted by the same reference signs in Figures. For the explanation thereof, reference is also made in part to the description of other exemplary embodiments and/or Figures in order to avoid repetitions.

The following detailed description of the exemplary embodiments illustrated in the figures serves for more detailed illustration or clarification and is not intended to limit the scope of the present invention in any way.

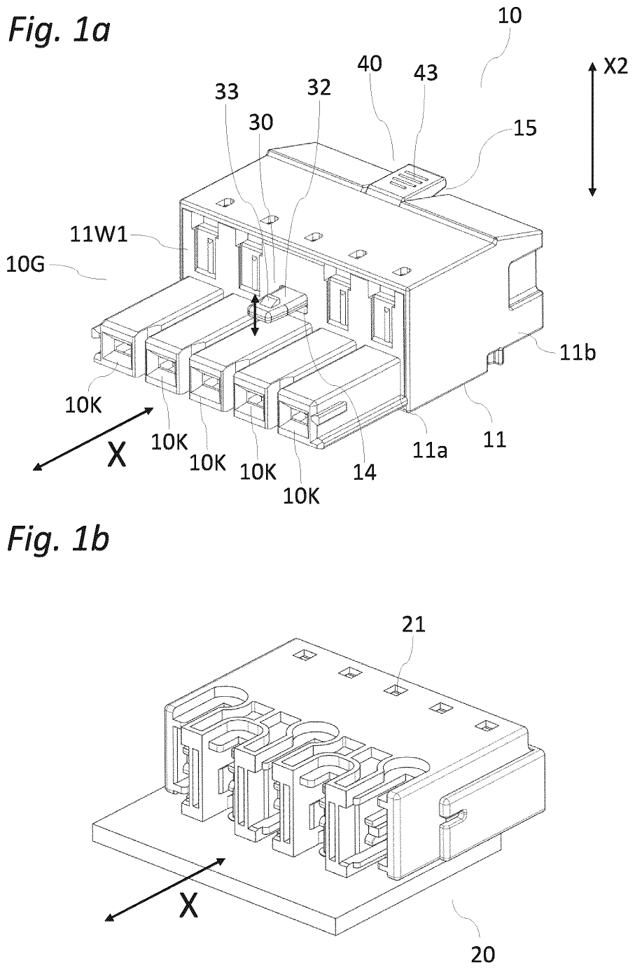

FIG. 1a shows a perspective view of an exemplary embodiment of a plug connector 10 according to the present invention.

The plug connector 10 comprises a two-part housing 11 with a first housing part 11a and a second housing part 11b. The first housing part 11a and the second housing part 11b are preferably configured to form a plug connection, that is to say a housing plug connection, and can furthermore form latching connections in order to avoid an undesirable release from one another.

Both the first housing part 11a and the second housing part 11b can preferably be produced from an insulating material, for example by at least one injection process and/or by at least one casting process. The insulating material can, for example, be a castable and/or injectable plastic. It is also possible for the first housing part 11a and the second housing part 11b to be produced by at least one sintering process, at least one 3D printing process and/or by at least one adhesive process.

On the side of the plug-in face 10G of the plug connector 10, the plug connector 10 has five plug-in contacts 10K which are arranged in a row transversely to the plug-in direction X in a longitudinal direction of the plug connector 10. The plug connector 10 is designed in the form of a row plug connector. Starting from a first end wall 11W1 of the first housing part 11a, the plug-in contacts 10K extend in the plug-in direction X and accommodate corresponding contact elements for producing an electrically conductive connection (not shown in FIG. 1a).

The first end wall 11W1 extends at its outer side which contributes to the plug-in face 10G of the plug connector 10 substantially perpendicular to the plug-in direction X. A passage 14 is formed in the central region of the first end wall 11W1. In one view, preferably in the plug-in direction X, the passage 14 has a substantially rectangular contour.

As can be seen from the representation in FIG. 1a, a locking portion 32 of a locking element 30 projects through the passage 14. The locking element 30 is arranged in the housing 11, i.e., in the region of the first housing part 11a and the second housing part 11b, and is correspondingly mounted, which is described in more detail below. The locking portion 32 comprises a latching element 33. The latching element 33 is arranged on the locking portion 32 on the side facing away from the plug-in contacts 10K. The latching element 33 is preferably integrally formed with the locking portion 32. The locking element 30 is described in more detail below with reference to further figures.

On the side opposite the plug-in face 10G, an actuating opening 15, which is configured and/or designed to accommodate on the housing 11 and thus on the second housing part 11b, an actuating element 40, preferably in the plug-in direction X. Both the shown actuating opening 15 and the actuating element 40 are described in more detail below.

FIG. 1b shows a perspective view of an exemplary embodiment of a mating plug connector 20. The mating plug connector 20 is configured and/or designed to form an electrical plug connection with the plug connector 10 shown in FIG. 1a. Analogous to the housing 11 of the plug connector 10, the housing of the mating plug connector 20 can also be correspondingly produced from an insulating material.

For locking the electrical plug connection between the plug connector 10 and the mating plug connector 20, the mating plug connector 20 has the latching portion 21 on a corresponding wall portion. The latching portion 21 is designed as a recess with a rectangular cross section and is configured to engage with the latching element 33 of the plug connector 10 when an electrical plug connection is formed and thus to lock the electrical plug connection by means of the locking element 30 by forming a latching connection between the latching element 33 and the latching portion 21.

The mating plug connector 20 also comprises, inter alia, contact elements for producing an electrically conductive connection, which, however, is not described in more detail herein.

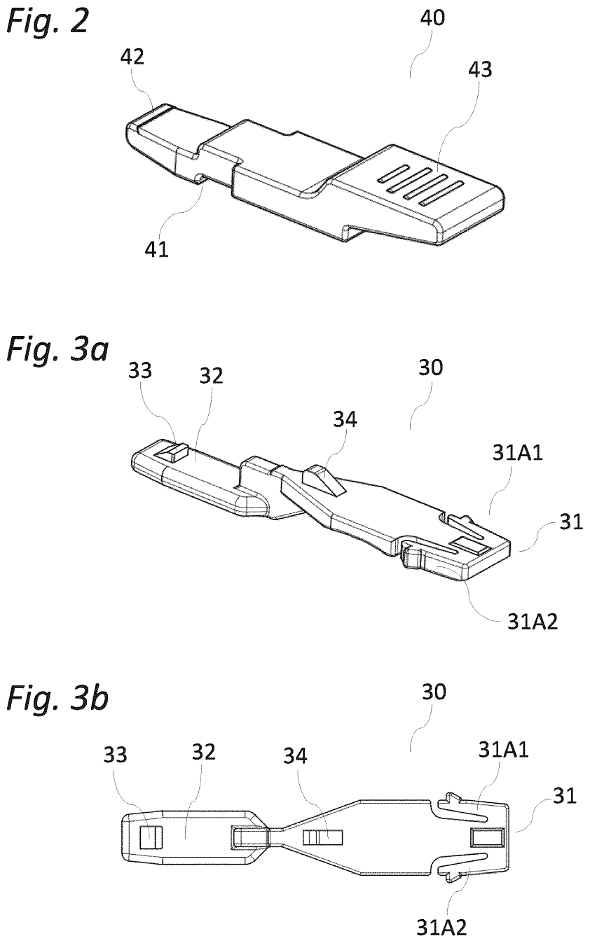

FIG. 2 is a perspective view of an exemplary embodiment of an actuating element 40 of a plug connector 10 according to the present invention. The actuating element 40 in FIG. 2 corresponds to the actuating element 40, which is partially visible in FIG. 1a and which is arranged in and/or accommodated in the plug connector 10.

The actuating element 40 is preferably designed as a flat lever element and comprises at a free end an operating portion 43 for manual operation, i.e., actuation of the actuating element 40 when the actuating element 40 is arranged in the housing 11 of the plug connector 10. On the side of the actuating element 40 opposite the operating portion 43, the support portion 42 is located at a further free end, which support portion serves to support and pivotally mount the actuating element 40 within the housing 11 of the plug connector 10. Furthermore, the actuating element 40 comprises the engagement portion 41 for forming an operative connection with an actuating portion 34 of the locking element 30, which is described in more detail below:

Analogous to the housing 11, that is to say the housing parts 11a, 11b, the actuating element 40 can be correspondingly produced from an insulating material. The actuating element 40 preferably serves as a lever for transmitting a movement and force to the locking element 30 as a result of an actuation of the actuating element 40 via the operating portion 43.

FIG. 3a now shows a perspective view of an exemplary embodiment of a locking element 30 of a plug connector 10 according to the present invention.

The locking element 30 corresponds to the locking element 30 partially visible in FIG. 1a. Analogous to the actuating element 40, the locking element 30 is preferably also designed as a flat lever element and at a free end comprises the clamping portion 31 with the two latching terminals 31A1 and 31A2 arranged toward the outside. The clamping portion 31 serves to support the locking element 30 in the housing 11 of the plug connector 10, which is explained in more detail below in the description of the further figures.

The locking element 30 is designed to be plate-shaped at least in certain portions and/or flat. The locking portion 32 with the latching element 33 is located at the free end, which is arranged opposite the clamping portion 31. The actuating portion 34 is arranged on the locking element 30 between the latching element 33 and the clamping portion 31 in the central region of the locking element 30.

In one view, preferably in a side view of the locking element 30, both the latching element 33 and the actuating portion 34 have a substantially trapezoidal or substantially wedge-shaped contour. The locking element 30 can preferably be integrally formed with the described elements or components.

The locking element 30 is preferably further designed to be resilient at least in certain portions and can thereby be reversibly deformed. The region or portion between the actuating portion 34 and the clamping portion 31 can preferably be of resilient design.

FIG. 3b shows a front view of the locking element 30 shown in FIG. 3a for further visualization. As a result, the locking element 30 tapers continuously in the direction of the locking portion 32 in the region of the actuating portion 34 in order then to transition into the locking portion 32.

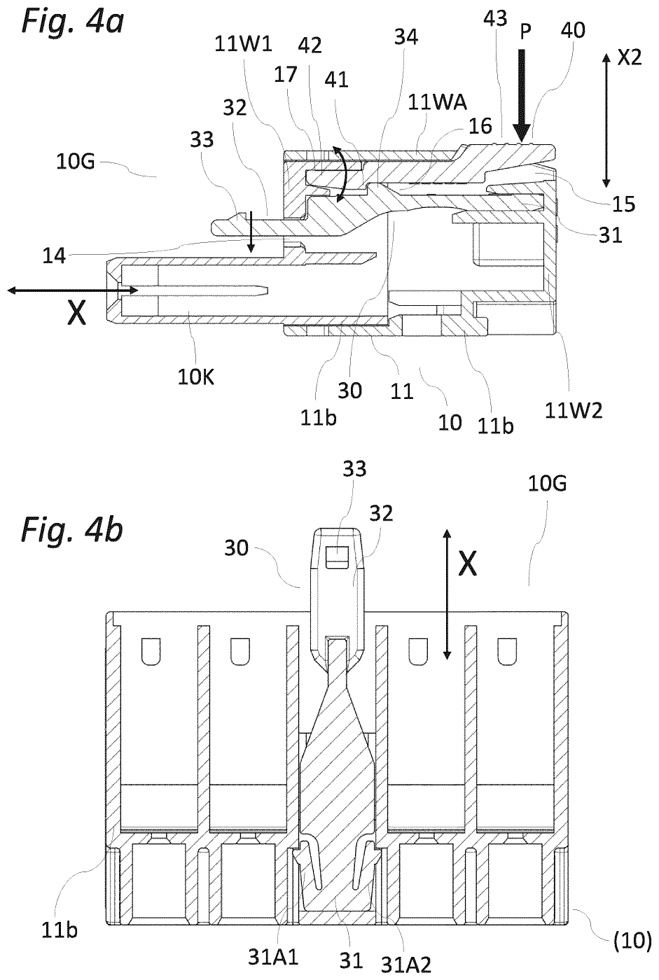

FIG. 4a shows a sectional view (side view) of the plug connector 10 shown in FIG. 1a with an actuating element 40 accommodated and/or arranged in the housing 11 of the plug connector 10.

It can clearly be seen from FIG. 4a that the housing 11 is formed by a first housing part 11a and by a second housing part 11b. The first housing part 11a is connected to the second housing part 11b via a plug connection and thus via a positive-locking connection. Furthermore, it can be seen in FIG. 4a that the visible plug-in contact 10K extends at least partially from the first end wall 11W1 in the plug-in direction X.

Above the plug-in contact 10K, i.e., at a distance therefrom, the passage 14 is formed in the first end wall 11W1. The locking portion 32 of the locking element 30 extends through the passage 14 in the plug-in direction X. The locking element 30 is fastened with its clamping portion 31 to the second end wall 11W2, preferably clamped at least in certain portions and/or latched at least in certain portions. The second end wall 11W2 is located on the side of the plug connector 10 opposite the plug-in face 10G in the plug-in direction X on the second housing part 11b.

Due to the one-sided mounting of the locking element 30 via the clamping portion 31 and the at least partially resilient design of the locking element 30, the locking element 30 can be actuated accordingly, so that a reversible deformation occurs. In particular, the locking portion 32 thus moves with the latching element 33 in the second direction X2, i.e., substantially perpendicular to the plug-in direction X.

The actuating element 40 is received via the actuating opening 15 in the first housing part 11a and in the second housing part 11b. In other words, the actuating element is arranged in the guide channel 16. The guide channel 16 is formed at least in certain portions by the locking element 30 and/or the outer wall 11WA. The actuating opening 15 is designed for insertion of the actuating element 40 for the locking element 30, preferably in plug-in direction X. The actuating opening 15 is arranged and/or formed on the housing 11, i.e., on the second housing part 11b on the side of the plug connector 10 opposite the plug-in face 10G in the plug-in direction X.

The actuating element 40 is received with its support portion 42 in the bearing portion 17 of the first end wall 11W1. The actuating element 40 contacts the actuating portion 34 of the locking element 30 with its engagement portion 41 and thereby forms an operative connection. Due to the corresponding geometric design of the locking element 30 and the resilient deformation properties of the locking element 30, the locking element 30, due to its arrangement and mounting in the second housing part 11b, clamps the actuating element 40, at least in certain portions, to the outer wall 11WA of the second housing part 11b in the unactuated state. Furthermore, the actuating element 40 is prevented by the operative connection and the support on the bearing portion 17 from moving in the plug-in direction X. The actuating element 40 is thus mounted in the housing 11 in a correspondingly clamped manner and can thus not detach from the plug connector 10 without corresponding application of force.

In this view, the bearing portion 17 has, at least in certain portions, a substantially U-shaped or substantially wedge-shaped contour for receiving the support portion 42 of the actuating element 40. As a result, a pivoting movement of the actuating element 40 about an axis of rotation or pivoting axis arranged transversely to the plug-in direction X is possible, so that the actuating element 40 can be pivotably actuated via the operating portion 43 by application of a pressing force P.

The pivoting movement of the actuating element 40 is transmitted from the engagement portion 41 to the actuating portion 34 of the locking element 30, after which a portion of the locking element 30 deforms resiliently and thus reversibly, so that a movement of the locking portion 32 with the latching element 33 is made possible substantially in the second direction X2.

FIG. 4b shows a sectional view (plan view) of the second housing part 11b of the plug connector 10 shown in FIG. 1a with the locking element 30 arranged therein, i.e., mounted on one side via the clamping portion 31.

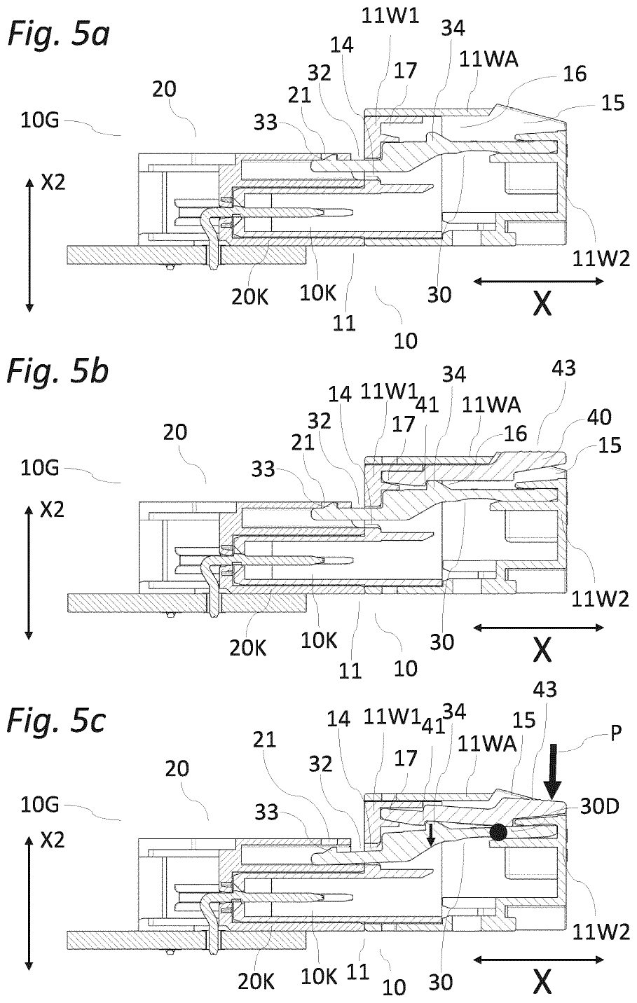

FIG. 5a shows a sectional view (side view) of the plug connector 10 shown in FIG. 1a when an electrical plug connection is formed with the mating plug connector 20 shown in FIG. 1b in a locked state. In this case, the plug connector 10 does not have an actuating element 40. The guide channel 16 and the actuating opening 15 are clearly visible in the housing part 11b via which the actuating element 40 can optionally be inserted, preferably in the plug-in direction X, for actuating the locking element 30.

The latching element 33 of the locking portion 32 engages in the latching portion 21 of the mating plug connector 20 and thus locks the electrical plug connection formed between the plug connector 10 and the mating plug connector 20.

FIG. 5b shows a further sectional view (side view) of the plug connector 10 shown in FIG. 1a when an electrical plug connection is formed with the mating plug connector 20 shown in FIG. 1b in a locked state, wherein the actuating element 40 is inserted in the plug connector 10. The actuating element 40 contacts the outer wall 11WA at least in certain portions and is thus shown in an unactuated state.

FIG. 5c now shows a further sectional view (side view) of the plug connector 10 shown in FIG. 1a when an electrical plug connection is formed with the mating plug connector 20 shown in FIG. 1b in an unlocked state, wherein the actuating element 40 is inserted in the plug connector 10 and this is actuated by means of the pressing force P applied to the operating portion 43 of the actuating element 40.

In order to illustrate the resilient and thus reversible deformation of the corresponding portion of the locking element 30 when the actuating element 40 is actuated via the operative connection between the engagement portion 41 and the actuating portion 34, the pivot point or swivel point 30D about which the corresponding part or portion of the locking element 30 carries out a reversible deformation is provided as a representative illustration.

With the locking mechanism provided according to the present invention with the division into the locking element and actuating element, a simple but reliable and above all secure locking of an electrical plug connection can preferably be ensured. It is possible for the plug connector 10, i.e., the locking element 30, to be operated without an actuating element 40 via the actuating opening 15, for example by means of a tool to be inserted. As a result, for example, unintentional pulling of the plug connector 10 from the mating plug connector 20 can be prevented or avoided.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 Plug connector
10K Plug-in contact
11 Housing
11a First housing part
11b Second housing part
11WA Outer wall
11W1 First end wall
11W2 Second end wall
14 Passage
15 Actuating opening
16 Guide channel
17 Bearing portion
20 Mating plug connector
20K Mating plug-in contact
21 Latching portion
30 Locking element
30D Pivot point/swivel point
31 Clamping portion
31A1, 31A2 Latching clamp
32 Locking portion
33 Latching element
34 Actuating portion
40 Actuating element
41 Engaging portion
42 Support portion
43 Operating portion
P Compressive force
X Plug-in direction
X2 Second direction

1. A plug connector, comprising:
at least one plug-in contact configured to form an electrical plug connection with at least one mating plug-in contact of a mating plug connector, in a plug-in direction,
wherein on a side of a plug-in face of the plug connector, the at least one plug-in contact extends at least partially from a first end wall of a housing of the plug connector in the plug-in direction,
wherein the plug connector has a locking element configured to lock the electrical plug connection with the mating plug connector, the locking element being arranged in the housing and extending at least partially through a passage in the first end wall in a direction of the at least one plug-in contact,
wherein the locking element is resilient at least in certain portions and is mounted in the housing, and
wherein the locking element is accessible via an actuating opening on the housing and is actuatable in at least one second direction.

2. The plug connector of claim 1,
wherein the actuating opening is formed on the housing on a side of the plug connector opposite the plug-in face in the plug-in direction and/or is configured for insertion of an actuating element for the locking element.

3. The plug connector of claim 1,
wherein a clamping portion of the locking element, on a side of the plug connector opposite the plug-in face in the plug-in direction, is fastened to a second end wall of the housing at least in certain portions.

4. The plug connector of claim 1,
wherein the locking element, outside the housing, has a locking portion having a latching element configured to form a releasable latching connection with a latching portion of the mating plug connector.

5. The plug connector of claim 1,
wherein the locking element has an actuating portion, and
wherein the actuating portion is arranged on the locking element between the passage and the actuating opening.

6. The plug connector of claim 1,
wherein the plug connector has a guide channel for inserting an actuating element.

7. The plug connector of claim 6,
wherein the guide channel is formed at least in certain portions by the locking element and/or by an outer wall of the housing adjoining the actuating opening.

8. The plug connector of claim 6,
wherein the guide channel is delimited in the plug-in direction at least by the first end wall on the side of the plug-in face, and
wherein the first end wall has a bearing portion for pivotable mounting of the actuating element.

9. The plug connector of claim 8,
wherein the bearing portion, in one view, has, at least in certain portions, a wedge-shaped or U-shaped contour configured to receive a support portion of the actuating element.

10. The plug connector of claim 1,
further comprising:
an actuating element clamped at least in certain portions to the outer wall by the locking element while it is inserted through the actuating opening and in the non-actuated state.

11. The plug connector of claim 10,
wherein the actuating element has an engagement portion which forms with the locking element, an operative connection for actuating the locking element via the actuating element and/or to hold the actuating element in the housing by the locking element.

12. The plug connector of claim 1, wherein the plug connector comprises a row plug connector.

13. The plug connector of claim 12, wherein the mating plug connector comprises a row mating plug connector.

14. The plug connector of claim 1, wherein the locking element extends in the plug-in direction.

15. The plug connector of claim 1, wherein the at least one second direction is perpendicular to the plug-in direction.

16. The plug connector of claim 2, wherein the actuating opening is configured for insertion of the actuating element in the plug-in direction.

17. The plug connector of claim 3, wherein the clamping portion is fastened to the second end wall of the housing at least in certain portions by being clamped at least in certain portions and/or latched at least in certain portions.

18. The plug connector of claim 4, wherein the locking portion is plate-shaped and/or the latching element has a trapezoidal or triangular contour in one view.

19. The plug connector of claim 18, wherein the latching element has the trapezoidal or triangular contour in one view, the one view comprising a side view.

20. The plug connector of claim 5, wherein the actuating portion is configured for actuation by an actuating element.
